(19) United States
(12) Patent Application Publication
(10) Pub. No.: US 2025/0072567 A1
(43) Pub. Date: Mar. 6, 2025

(54) SHOE, SHOE PRODUCTION SYSTEMS AND METHOD FOR PRODUCING A SHOE

(71) Applicant: ON CLOUDS GMBH, CH-8005 ZÜRICH (CH)

(72) Inventors: Johannes VOELCHERT, Zürich (CH); Elias Miguel ORTIZ, Zürich (CH); Renaud DESPOTS ALLAIRE, Zürich (CH); Jean-Philippe ROMAIN, Zürich (CH); Nils Arne ALTROGGE, Zürich (CH)

(73) Assignee: ON CLOUDS GMBH, CH-8005 ZÜRICH (CH)

(21) Appl. No.: 18/816,140

(22) Filed: Aug. 27, 2024

(30) Foreign Application Priority Data
Aug. 31, 2023 (CH) 000937/2023

(51) Int. Cl. A43D 86/00

(52) U.S. Cl. CPC A43D 86/00

(57) ABSTRACT

A shoe, a shoe production system and a method for producing a shoe including the steps: a. providing an upper assembly (2), wherein the upper assembly includes an upper (3) being mounted on a carrier (4), wherein the upper (3) includes a bottom section (5) being made from a thermoplastic polymer upper material; b. providing a sole molding unit (6), wherein the sole molding unit defines a cavity; c. inserting the upper assembly (2) at least partially into the cavity; introducing a midsole polymer composition comprising a molten thermoplastic polymer midsole material which has a melting temperature being equal or higher than the melting temperature of the thermoplastic polymer upper material into the cavity and foaming the molten thermoplastic polymer midsole material inside the cavity to provide a foamed midsole and to establish a material-bonded connection between the upper (3) and the foamed midsole (8).

### CROSS-REFERENCE TO RELATED APPLICATIONS

Swiss Patent Application Nos. CH 000937/2023, filed 31 Aug. 2023, the priority document, corresponding to this invention, to which a foreign priority benefit is claimed under Title 35, United States Code, Section 119, and its entire teachings are incorporated, by reference, into this specification.

### FIELD OF THE DISCLOSURE

The present invention lies in the field of shoe manufacturing technology and relates in particular to a method for producing a shoe, a shoe and a shoe production system.

### BACKGROUND OF THE DISCLOSURE

Sports shoes, in particular running shoes, consist typically of a sole and an upper. The upper is usually a textile, such as a knit or a woven fabric. Commonly, the upper is produced as a flat textile material, e.g. a flat knit or a flat woven fabric. Such flat textile materials are sometimes referred to as 2D structures. The flat textile material is typically produced with a knitting or weaving machine and is then mounted on a last. Alternatively, circular knits are commonly used. The sole of common running shoes comprises a midsole, which is typically foamed to effect cushioning, and a wear resistant outsole to protect the midsole. Furthermore, the sole may comprise an insole which is in contact with the wearer's foot. In the prior art, the sole and often even the midsole and the outsole, and the upper are produced separately and with different machines. Depending on the production method it may even be necessary to use multiple machines only for sole production. During production, the lasted upper is connected to the sole typically by using an adhesive to establish a material-bonding connection between upper and sole. In addition, stitching can be used to support the connection between upper and sole. For such a process, human workforce is required and the produced intermediate parts have to be transported from one machine to another. For example, midsole foam molding is typically done by inserting a granulated polymer manually into a mold, closing the mold and foaming, manually removing the midsole and manually removing offcut material. Then the produced soles are taken to another workstation where they are adhered to a lasted upper. This separation of steps and relatively large demand of human workforce makes the production process laborious and inefficient.

Classic foam molding further suffers from various drawbacks. For example, the soles often expand after deforming and thus an accurate size control is difficult. Furthermore, the molds must be heated which increases the energy consumption of the process. From an environmental point of view, traditional foam molding emits a large amount of volatile organic compounds (VOCs).

### SUMMARY OF THE DISCLOSURE

It is the general object of the present invention to advance the state of the art in shoes and shoe manufacturing and preferably to overcome the disadvantages of the prior art fully or partly. In advantageous embodiments, a method and a shoe production system is provided which is more efficient and/or reduces the required human workforce and/or reduces the demand of resources and/or waste, and/or is less harmful to the environment. In further advantageous embodiments, a shoe is provided which has been produced by such a method or with such a shoe production system. Such a shoe has a smaller ecological footprint and is cheaper in production costs.

The general object is achieved by the subject matter of the independent claims. Further advantageous embodiments follow from the dependent claims and the overall disclosure.

A first aspect of the invention relates to a method for producing a shoe. The method comprises steps a. to d. as discussed further below. It should be noted however, that as used herein, designations of steps such as a., b., or d. are not to be understood as defining a specific order of steps, but serve to unambiguously identify a specific step. Therefore, while it may be the case in some embodiments that step a. is followed by step b., which is followed by step c., which is followed by step d., it may well be possible in some other embodiments that for example step b. is performed before and/or during step a.

Step a. comprises: providing an upper assembly. The upper assembly comprises an upper which is mounted on a carrier. The upper comprises a bottom section which is made from a thermoplastic polymer upper material. It should be noted that it is also possible that the rest of the upper, or another portion thereof may be made from the same thermoplastic polymer upper material or from a different material. Typically, however, at least the bottom section is made from the thermoplastic polymer upper material. Preferably, the majority of the upper (i.e. more than 50 wt. %) or even all of the upper may be made from the same thermoplastic polymer upper material.

Step b. comprises: providing a sole molding unit which defines a cavity. The cavity is typically configured for producing a sole of a shoe, particularly a midsole. In preferred embodiments, the cavity is delimited by one or more sidewalls which circumferentially surround the cavity and a bottom wall which delimits the bottom of the cavity. In some embodiments, the cavity is however open at the top portion, i.e. the portion being oppositely arranged to the bottom portion. This opening and the upper assembly may preferably be configured such that upon inserting the upper assembly at least partially into the cavity, the top portion of the cavity is closed by the upper assembly, in particular hermetically closed.

Step c. comprises: at least partially, or fully, inserting the upper assembly provided in step a. into the cavity defined by the sole molding unit. Typically, step c. is performed such that at least a part, or all, of the bottom section of the upper is inserted into the cavity of the sole molding unit. By inserting the upper assembly at least partially, or fully, into the cavity a sole molding compartment is preferably formed. This sole molding compartment may be delimited, in particular only delimited, by the sole molding unit and the inserted upper assembly. It is understood that the sole molding compartment is configured such that by introducing and foaming a midsole polymer composition, a midsole can be formed therein. The sole molding compartment may typically be part of or arranged inside the cavity.

Step d. comprises: introducing, in particular injecting, a midsole polymer composition comprising a molten thermoplastic polymer midsole material into the cavity and foaming the molten thermoplastic polymer midsole material inside the cavity. By introducing and foaming the molten thermoplastic polymer midsole material, a foamed midsole is provided and a material-bonded connection, in particular a direct material-bonded connection, more particular a fused connection, between the upper, in particular the bottom section of the upper, and the foamed midsole is established. The molten thermoplastic polymer midsole material has a melting temperature which is equal to or higher than the melting temperature of the thermoplastic polymer upper material. This has the effect that upon introduction of the molten thermoplastic polymer midsole material into the cavity and its foaming in the cavity, the molten thermoplastic polymer midsole material contacts and melts the bottom section of the upper being inserted into the cavity. In other words, upon introducing, particularly injecting, the midsole polymer composition into the cavity, the thermoplastic polymer midsole material contacts and melts at least parts of or the whole bottom section of the upper. Thus, a direct material-bonded connection between upper and midsole is formed which is free of any additional external adhesive, but may be considered as a fused connection between upper and foamed midsole. This allows not only to avoid additional process steps or materials, but it also establishes a much firmer and more reliable connection between upper and midsole. The midsole polymer composition may for example be introduced into the sole molding compartment being delimited by the upper assembly and the sole molding unit. In such embodiments, the shape of the sole molding compartment defines the shape of the foamed midsole. Typically, the molten thermoplastic polymer upper material is introduced into the cavity and directly foamed therein.

As used herein, it is understood that the term “melting temperature” may for example refer to a specific melting point, e.g. in case a single or pure material is used as thermoplastic polymer upper material or thermoplastic polymer midsole material, or can also relate to a melting temperature range, for example when a mixture of different base materials is used as thermoplastic polymer upper material or thermoplastic polymer midsole material.

The bottom section of the upper is typically arranged at the bottom of the carrier and may preferably be the section forming the peripheral lower delimitation of the upper in the produced shoe at the transition to the foamed midsole. The bottom section may typically circumferentially surround the foot of the wearer. The bottom section may also be the region of the upper being in the worn state arranged underneath the foot of the wearer, respectively during production between the carrier and the foamed midsole. For example, the bottom section may extend up to 3 cm in the vertical direction of the upper.

As used herein, the term “thermoplastic polymer upper material” is used to indicate that this material is the thermoplastic polymer material which is present in the upper of the formed shoe. Accordingly, the term “thermoplastic polymer midsole material” is used to indicate that this material is the thermoplastic polymer material which is present in the midsole of the formed shoe. The thermoplastic polymer upper material and the thermoplastic polymer midsole material may in some embodiments be the same material or they may also be different materials. Accordingly, the term “thermoplastic polymer outsole material” is used to indicate that this material is the thermoplastic polymer material which is present in the outsole of the formed shoe. The thermoplastic polymer upper material, the thermoplastic polymer midsole material and the thermoplastic polymer outsole material may in some embodiments be the same material or they may also be different materials.

As used herein, a direct material-bonded connection of two elements means that they are connected with each other without an additional adhesive. For example, a direct material-bonded connection may be a fused connection in which the two elements are fused to each other.

It is generally understood herein that the term “comprising” is interpreted as meaning that it includes those features following this term, but that it does not exclude the presence of other features, as long as they do not render the claim unworkable. On the other hand, if the wording “consist of” is used, then no further features are present in the corresponding apart from the ones following said wording.

The abbreviation “SCIF” as used herein is an abbreviation for supercritical injection foaming.

Generally, the molten thermoplastic polymer midsole material can be provided by melting a thermoplastic polymer midsole material, for example in a melting unit or in an extruder, e.g. inside a screw and barrel extruder. For example, the thermoplastic polymer midsole material can be provided as a granulate which can be melted.

In some embodiments, the carrier is removed from the upper after step d.

The carrier may preferably be a last, e.g. a shoe last, or at least a portion of a last. Such a last may for example be a standardized last for a particular shoe size or it may also be a customized last, e.g. a last which has been produced based on a preceding scan of the foot of a wearer. A last may be provided by molding, additive manufacturing or by subtractive manufacturing, such as milling.

In some embodiments, the foamed midsole is cooled after step d.. This may be done either in the cavity or after removal of the foamed midsole and the thereto material-bonded, in particular fused, upper from the cavity.

It is understood that the sole molding unit typically comprises, respectively defines, one or more injection openings being configured for introducing the midsole polymer composition into the cavity, respectively into the sole molding compartment.

In some embodiments, step d. is performed by, respectively comprises or consists of, supercritical injection foaming (SCIF). SCIF has the advantage that the volatile organic compound emissions are significantly reduced as compared to conventional foaming. Furthermore, in contrast to other foaming techniques, it is not necessary to use nucleating agents and/or to coat the mold with chemical agents for facilitating demolding. Therefore, SCIF is more environmentally friendly and easier to perform.

SCIF as used in some embodiments of the invention, may comprise the injection of the midsole polymer composition into the cavity, preferably by an injection unit, for example an extruder, such as a screw and barrel extruder. The midsole polymer composition may in such embodiments comprise, or consist of, a molten thermoplastic polymer midsole material and a supercritical fluid, e.g. N₂ or CO₂.

The midsole polymer composition used in SCIF in some embodiments of the invention may be injected in step d. into the cavity as a single phase, i.e. as a homogenous single phase.

In some embodiments using SCIF, the midsole polymer composition is injected into the cavity, wherein the pressure in the cavity is lower than the pressure in the injection unit, in particular in the barrel of the extruder. This has the effect that foaming occurs directly upon injection and ceases when the cavity, in particular the sole molding compartment, is filled at the maximum filling capacity under the applied conditions. These conditions may in particular comprise the pressure in the cavity and the injection unit. Due to the lower pressure in the cavity and the SCIF method in general, the foamed midsole does not expand after deforming. Thus, the cavity dictates directly and accurately the size of the foamed midsole. For example, the pressure in the cavity may be between 800 bar to 1200 bar, in particular 900 bar to 1000 bar, lower than the pressure in the injection unit.

In some embodiments, the cavity is pressurized to a first cavity pressure above atmospheric pressure, prior and/or during injection of the midsole polymer composition. The first cavity pressure may be provided as a gas counter pressure to the cavity.

In some embodiments, foaming the molten thermoplastic polymer midsole material can generally be achieved by decreasing the first cavity pressure to a second cavity pressure being lower than the first cavity pressure. Thereby, formation of gas bubbles of the physical blowing agent occurs which effects foaming of the molten thermoplastic polymer midsole material. The second cavity pressure may in some embodiments be atmospheric pressure.

Decreasing the pressure in the cavity from the first cavity pressure to the second cavity pressure may be achieved by venting of the cavity, by a continuous pressure decrease at a predefined rate (e.g. by a valve or by decreasing a counter gas pressure being applied to the cavity) or by a stepwise decrease. The predefined rate may for example be between 0.5 bar/s to 50 bar/s, in particular 1 bar/s to 20 bar/s, more particular 1 bar/s to 10 bar/s.

In some embodiments, the pressure in the cavity, i.e. the first cavity pressure, may be between 10 bar to 200 bar, in particular 40 bar to 100 bar. In some embodiments, the pressure in the injection unit, e.g. in the barrel of the extruder, may be between 900 bar to 1200 bar, in particular 1000 to 1100 bar.

In some embodiments, the polymer composition in step d. comprises a physical blowing agent. Typically, the physical blowing agent may be mixed together with the thermoplastic polymer midsole material prior to introducing the midsole polymer composition into the cavity. It may in certain embodiments be for example possible to mix the physical blowing agent with the thermoplastic polymer midsole material in the injection unit, e.g. in the barrel of the screw and barrel extruder. It may also be possible to infuse the physical blowing agent into the thermoplastic polymer midsole material prior to or during melting of the thermoplastic polymer midsole material.

The blowing agent may preferably be a physical blowing agent, such as N₂ or CO₂. As understood by the skilled person, a physical blowing agent is a blowing agent which can induce foaming upon changing the physical state of the blowing agent or the physical conditions, such as pressure and/or temperature to induce foaming. In contrast, a chemical blowing agent is a blowing agent which releases a gas upon a chemical reaction, for example the release of N₂ from a diazo moiety. Although it is in some embodiments possible to employ a chemical blowing agent, physical blowing agents are generally preferred. In particular embodiments, the physical blowing agent is in a supercritical state, e.g. in the injection unit, respectively in the screw and barrel extruder. This may for example be the case in embodiments in which step d. is performed by SCIF.

In some embodiments, the bottom section of the upper is during step d. at least partially or completely melted. In certain embodiments, the bottom section is at least partially or completely melted by the thermal energy of the molten thermoplastic polymer midsole material. This means, the thermal energy provided by the molten thermoplastic polymer midsole material is transferred to the bottom section upper upon which the latter melts. In particular embodiments, the bottom section is at least partially or completely melted only by the thermal energy of the molten thermoplastic polymer midsole material. This means, no additional thermal energy must be provided.

In certain embodiments, the bottom section of the upper is covered prior to step d. and in particular prior to step c., by a thermoplastic film being preferably made from the thermoplastic polymer midsole material.

In some embodiments, the sole molding unit is free of heating and/or cooling elements. This not only makes the sole molding unit less complex, but also improves production efficiency and the ecological footprint of the production process. In some embodiments, the sole molding unit is not heated or cooled during step d. and/or any of steps a. to d..

In some embodiments the upper assembly is inserted in step c. in such a manner into the sole molding unit that a closed sole molding compartment is formed which is defined by the sole molding unit and the upper assembly, in particular only by the sole molding unit and the upper assembly. It is understood that also in such embodiments, the sole molding unit may preferably comprise, respectively define, one or more injection inlets for introducing the midsole polymer composition into cavity, respectively into the sole molding compartment. The sole molding compartment formed is typically arranged within the cavity of the sole molding unit. Upon insertion of the upper assembly into the cavity, the upper, in particular the bottom section of the upper is inserted into the cavity of the sole molding unit.

In particular embodiments, the upper assembly is inserted in step c. in such a manner into the sole molding unit that a closed and sealed sole molding compartment is formed being defined by the sole molding unit and the upper assembly. In certain embodiments, the upper assembly is configured such that it forms a sealing element, such as a sealing lip which provides for a fluid tight connection between the sole molding unit and the upper assembly. The sealing element may for example be a part of the upper, particularly an integral part of the upper. Alternatively, the sealing element may be releasably connected to the upper and/or the carrier. As understood by the skilled person, a releasable connection as used herein is a connection which can be released without destroying the structural integrity of the connected elements. Optionally, a releasable connection can be released and reconnected multiple times. Thus, a form-locking and/or force locking connection may be considered a releasable connection, while a material-bonding connection is not.

In some embodiments, an outsole polymer composition, which comprises a molten polymer outsole material, in particular a molten thermoplastic outsole material, is introduced into the cavity after step d. to provide an outsole being material-bonded to the foamed midsole. Preferably, the outsole provided is directly material-bonded to the foamed midsole. As used herein, a direct material-bonded connection of two elements means that they are connected with each other without an additional adhesive. For example, a direct material-bonded connection may be a fused connection in which the two elements are fused to each other. The outsole polymer material may in some embodiments be the same material than the thermoplastic polymer upper material and/or than the molten thermoplastic polymer midsole material. Providing an outsole in such a manner allows to generate a foamed midsole being material-bonded to the upper and an outsole being material-bonded to the foamed midsole in a single unit without having to move the parts and intermediate products between different locations.

In some embodiments, the upper assembly is held by a movable robotic arm, in particular during step c. and d. and/or during step a.. For example, step c. i.e. the insertion of the upper assembly into the cavity may be performed by the robotic arm. The robotic arm may for example be a cantilever. Preferably, the robotic arm is movable in the 3-dimensional space. The robotic arm may for example comprise one or more beams being connected with each other via joints thereby allowing the movement of the arm in the 3-dimensional space. In some embodiments, the robotic arm, particularly its movement in the 3-dimensional space, may be controlled by a control unit. The control unit may preferably comprise a circuit, e.g. a microprocessor. For example, a movement path may be stored in a memory unit which can be accessed by the control unit to move the robotic arm along this movement path. For step c. it may be possible that the robotic arm either holds the carrier of the upper assembly already before step c. or that the robotic arm first grips the carrier and then inserts it upper assembly at least partially into the cavity of the sole molding unit.

In some embodiments, the robotic arm can be used to remove the carrier after step d. to separate the produced shoe from the carrier.

In certain embodiments, the robotic arm may hold the upper assembly by holding the carrier. In particular, the robotic arm holds the upper assembly in a form-locking or force-locking manner. For example, the robotic arm and the carrier may be connected by a snap fit engagement or the robotic arms may comprise gripping elements with which it can grip the carrier of the upper assembly.

In some embodiments, the upper assembly is provided in step a. by producing the upper on the carrier. This may be done by applying the thermoplastic molten upper material which is comprised in at least the bottom section of the upper or from which the upper is made, onto the carrier by means of a nozzle in the form of at least one filament, particularly at least one continuous filament, to provide the upper being mounted on the carrier. In particular, the nozzle only applies one filament at the time onto the carrier. That is, if more than one filament is applied, the filaments are sequentially applied to the carrier.

In some embodiments, the at least one filament is applied in such a manner on the carrier that it forms a plurality of crossings with itself on the carrier and/or that it forms a plurality of loops on the carrier. In preferred embodiments, a material-bonded connection is established at at least one crossing between different sections of the at least one filament. For example, the filament may form a loop and thereby one section of the filament is laid on another section of the same filament. In typical embodiments, the filament is applied such that it is still in the molten state, and/or in a softened state as compared to the aggregate state of the thermoplastic polymer upper material after being stored for 24 h at 23° C. and at atmospheric pressure. Thus, when two sections of the same filament form a crossing, a direct material-bonding connection is formed at the crossing. This significantly improves the durability of the provided upper.

A loop as used herein is a section formed by the filament which starts at a crossing, extends along the thermoplastic filament and arrives again at the same crossing. For example a loop may have a round shape, in particular a circular or oval shape. It may also be possible that the loops have an irregular shape.

In some embodiments, the nozzle comprises a material outlet and a plurality of air openings being circumferentially arranged around the material outlet. In such embodiments, pressurized air is applied in such a manner onto the molten polymer upper material which exits the material outlet of the nozzle that it is applied on or to the carrier as a helical filament. This does not mean that the helical filament must necessarily extend completely between the nozzle and the carrier during application, although this may be the case in some embodiments. In some embodiments, the pressurized air being applied onto the molten polymer upper material has a temperature of more than 150° C., in particular of more than 200° C. In some embodiments, the pressurized air being applied onto the molten polymer upper material has a temperature at most 600° C., in particular of at most 400° C. In some embodiments, the pressurized air being applied onto the molten polymer upper material has a temperature of between 150° C. to 600° C., in particular of 200° C. to 400° C.

In certain embodiments, the nozzle is part of a depositing unit as described herein. It is in certain embodiments possible that the depositing unit, or at least the nozzle, is movable in the 3-dimensional space. The depositing unit may for example in some embodiments be controlled by a depositing unit control unit. The depositing unit control unit may preferably comprise a circuit, e.g. a microprocessor. For example, a movement path may be stored in a depositing memory unit which can be accessed by the depositing control unit to move the nozzle along this movement path. Furthermore, the pressure of pressurized air being applied onto the exiting molten thermoplastic polymer upper material can be controlled by the control unit. It may also be possible that the depositing rate or pressure of the molten thermoplastic polymer upper material on or to the carrier may be controlled by the control unit.

Embodiments in which a molten thermoplastic polymer upper material is applied onto the carrier by a nozzle as at least one filament are preferred, since the whole process from producing the upper on the carrier, generating the foamed midsole and connecting it to the upper in a direct material-bonding manner, e.g. by fusing upper and the foamed midsole together, and optionally also producing an connecting an outsole to the foamed midsole can be done at a single location and/or fully automatic. Thus, in preferred embodiments, the method for producing a shoe is fully automatic.

In some embodiments, during applying the thermoplastic polymer upper material onto the carrier, the upper assembly and the nozzle are moved relative to each other in the 3-dimensional space by moving the robotic arm holding the carrier and/or by moving the depositing unit, respectively the nozzle.

In some embodiments, the thermoplastic polymer midsole material is selected from polyolefins, such as polyethylene or polypropylene, polyester, such as PET or PBT, polyamide, polyether block amide (PEBAX), polyurethane, ethylene vinyl acetate (EVA) or mixtures thereof.

In some embodiments, the thermoplastic polymer upper material is selected from polyolefins, such as polyethylene or polypropylene, polyester, such as PET or PBT, polyamide, polyether block amide (PEBAX), polyurethane, ethylene vinyl acetate (EVA) or mixtures thereof.

In some embodiments, the polymer outsole material, in particular the thermoplastic polymer outsole material is selected from rubber, polyolefins, such as polyethylene or polypropylene, polyester, such as PET or PBT, polyamide, polyether block amide (PEBAX), polyurethane, ethylene vinyl acetate (EVA) or mixtures thereof.

The method according to any of the embodiments of the first aspect of the invention may in particular be performed by a shoe production system according to any of the embodiments described herein, in particular with respect to the third aspect of the invention.

According to a second aspect of the invention, a shoe is provided. In particular, the shoe has been obtained by the method according to any of the embodiments described with respect to the first aspect of the invention. The shoe comprises an upper, which comprises, or consists of, a thermoplastic polymer upper material. Furthermore, the shoe comprises a foamed midsole, which comprises a thermoplastic polymer midsole material. The upper and the foamed midsole are directly material-bonded to each other. In particular, the upper and the foamed midsole are fused to each other. Preferably, the connection of upper and foamed midsole is devoid of an external adhesive.

In some embodiments, the shoe further comprises an intermediate material zone. In the intermediate material zone, upper and foamed midsole are directly material-bonded to each other, in particular fused to each other.

Preferably, the intermediate material zone comprises the thermoplastic polymer upper material and the thermoplastic polymer midsole material. While it may in some embodiments be the case that the thermoplastic polymer upper material and the thermoplastic polymer midsole material are different materials, they may in some embodiments also be the same.

The intermediate material zone has preferably a certain thickness in the vertical direction. The vertical direction extends from the midsole towards the upper, or in the operative state from the midsole or the ground to the foot of the wearer. The thickness of the intermediate material zone in which both thermoplastic polymer upper material and thermoplastic polymer midsole material are present and/or in which upper and foamed midsole form a material-bonded connection, particularly are fused together, may be between 0.01 mm to 1 mm, in particular between 0.05 mm to 0.5 mm. In certain embodiments, the thermoplastic polymer midsole material and the thermoplastic polymer upper material are intermingled with each other in the intermediate material zone.

The intermediate material zone thus consists partly of thermoplastic polymer upper material and thermoplastic polymer midsole material and upper and midsole are therein directly material-bonded to each other. This results in a significantly durable and strong connection and thus improved stability of the shoe. Furthermore, the structure of the intermediate material zone may be different from the structure of the rest of the upper and/or the rest of the foamed midsole. For example, the intermediate material zone may have a different density and/or a different hardness than the rest of the upper and/or the rest of the foamed midsole. In some embodiments, the rest of the upper may have a loop structure, while preferably the intermediate material zone may be a massive material layer.

Typically, the rest of the upper, e.g. the part which is not part of the intermediate material zone (e.g. the upper section of the shoe) is preferably free of the thermoplastic polymer midsole material. Vice versa, the rest of the midsole, e.g. the part which is not part of the intermediate material zone (e.g. the midsole section of the shoe), is preferably free of the thermoplastic polymer upper material.

In some embodiments, the intermediate zone extends in a plane along the longitudinal direction and the transversal direction completely over the foamed midsole and/or completely over the upper. The longitudinal direction extends from a heel edge of the shoe to the shoe tip and is perpendicular to the vertical direction. The transversal direction extends perpendicular to the longitudinal and the vertical direction and extends from the lateral area to the medial area of the shoe.

The intermediate material zone may in some embodiments form an insole.

If the upper and the foamed midsole form a direct material-bonded connection with each other, i.e. if upper and foamed midsole are fused to each other, upper and foamed midsole are integral with each other.

In some embodiments, the intermediate material zone is arranged between a midsole section being devoid of the thermoplastic polymer upper material and an upper section being devoid of the thermoplastic polymer midsole material. In certain embodiments, the intermediate material zone is a layer separating the midsole section being devoid of the thermoplastic polymer upper material and the upper section being devoid of the thermoplastic polymer midsole material.

In some embodiments, the intermediate material zone comprises a gradient of the thermoplastic polymer upper material. This gradient preferably extends from the upper section to the midsole section. In other words, the gradient extends against the vertical direction of the shoe. This means the amount (in wt. %) of thermoplastic polymer upper material in the intermediate material zone decreases against the vertical direction, i.e. towards the foamed midsole.

In some embodiments, the intermediate material zone comprises a gradient of the thermoplastic polymer midsole material. This gradient preferably extends from the midsole section to the upper section. In other words, the gradient extends along the vertical direction of the shoe. This means the amount (in wt. %) of thermoplastic polymer midsole material in the intermediate material zone decreases along the vertical direction, i.e. towards the upper.

In some embodiments, the melting temperature of the thermoplastic polymer midsole material is equal or higher than the melting temperature of the thermoplastic polymer upper material. The thermoplastic polymer upper material may in some embodiments be the same or different than the thermoplastic polymer midsole material.

In some embodiments, the thermoplastic polymer midsole material is selected from polyolefins, such as polyethylene or polypropylene, polyester, such as PET or PBT, polyamide, polyether block amide (PEBAX), polyurethane, ethylene vinyl acetate (EVA) or mixtures thereof.

In some embodiments, the thermoplastic polymer upper material is selected from polyolefins, such as polyethylene or polypropylene, polyester, such as PET or PBT, polyamide, polyether block amide (PEBAX), polyurethane, ethylene vinyl acetate (EVA) or mixtures thereof.

A third aspect of the invention relates to a shoe production system, in particular an automated shoe production system. Such a shoe production system is preferably configured to perform the method described herein, in particular with respect to the embodiments of the first aspect of the invention. The shoe production system may also be used to produce a shoe as described herein, in particular with respect to the embodiments of the second aspect of the invention.

The shoe production system comprises a sole molding unit, in particular a sole molding unit as described herein, e.g. with respect to the first aspect of the invention. The sole molding unit defines a cavity. The shoe production system further comprises a movable robotic arm which is configured to hold a carrier of an upper assembly, i.e. an upper assembly as described herein.

In some embodiments, the cavity defined by the sole molding unit is delimited by one or more sidewalls which circumferentially surround the cavity and further a bottom wall which delimits, respectively defines, the bottom of the cavity. In some embodiments, the cavity is however open at the top portion, i.e. the portion being oppositely arranged to the bottom portion. This opening and the upper assembly may preferably be configured such that upon inserting the upper assembly at least partially into the cavity, the top portion of the cavity is closed by the upper assembly, in particular hermetically closed.

The robotic arm may for example be a cantilever. Preferably, the robotic arm is movable in the 3-dimensional space. The robotic arm may for example comprise one or more beams being preferably connected with each other via joints thereby allowing the movement of the arm in the 3-dimensional space.

In some embodiments, the robotic arm may be controlled by a control unit which may also be part of the shoe production system. The control unit may preferably comprise a circuit, e.g. a microprocessor. For example, a movement path may be stored in a memory unit which can be accessed by the control unit to move the robotic arm along this movement path. The memory unit may also be part of the shoe production system.

In some embodiments, the shoe production system comprises a depositing unit which is configured for depositing a thermoplastic polymer upper material on the carrier being held by the movable robotic arm. The depositing unit may be a depositing unit as described herein above, in particular with respect to embodiments described in the first aspect of the invention.

In some embodiments, the depositing unit comprises a nozzle. The nozzle may in certain embodiments comprise a material outlet and a plurality of air openings which are circumferentially arranged around the material outlet. The air openings are further configured to apply pressure in such a manner on the molten thermoplastic polymer upper material exiting the material outlet that the exiting molten thermoplastic polymer upper material is applied, respectively deposited, on or to the carrier as a helical filament.

In some embodiments, the depositing unit comprises further a melting unit. The melting unit is configured to transform a thermoplastic polymer upper material, in particular in solid form, into the molten thermoplastic polymer upper material, in particular by energy transfer, such as heating. For example, the melting unit may be an extruder or be part of an extruder, in particular an extruder with screw and barrel. The melting unit is preferably in fluid communication with the material outlet of the nozzle. Thus, the thermoplastic polymer upper material can be melted in the melting unit and can then be transported to the nozzle and applied through the material outlet of the nozzle on the carrier.

In certain embodiments, the depositing unit further comprises a pump, such as a dosing pump, which is configured to transport the molten thermoplastic polymer upper material out of nozzle and on the carrier.

It is in some embodiments possible that the depositing unit is movable in the 3-dimensional space. The depositing unit may for example in some embodiments be controlled by a depositing unit control unit. The depositing unit control unit may preferably comprise a circuit, e.g. a microprocessor. For example, a movement path may be stored in a depositing memory unit which can be accessed by the depositing control unit to move the robotic arm depositing along this movement path. In some embodiments, in which both the depositing unit is movable in the 3-dimensional space and in which the carrier is held by a movable robotic arm, the depositing unit control unit may also be part of or being equal to the control unit controlling the robotic arm holding the carrier.

In some embodiments, the depositing unit further comprises a motor being configured to drive the pump.

The control unit of the shoe production system may be configured to control the movement path of the robotic arm holding the carrier, and/or the movement path of the depositing unit as described below, and/or the pressure of the air being applied through the air openings of the nozzle onto the molten thermoplastic upper material exiting the material outlet of the nozzle, and/or the pump. The depositing control unit may for example be part of the control unit as such.

In some embodiments, the memory unit stores one or more of movement paths for the robotic arm being configured to hold the carrier and/or for the depositing unit, respectively its nozzle.

In some embodiments, the control unit may determine the movement path, in particular an ideal movement path, based on training data stored in the memory unit. Preferably, the determination of the movement path may be performed by machine learning.

Particularly, it may generally be possible that the robotic arm is configured to move the carrier and/or the upper assembly along three space axes, such as a vertical axis, a longitudinal axis and a transversal axis. Additionally, or alternatively, it may generally be possible that the movable robotic arm is configured for rotating the carrier and/or the upper assembly around a rotation axis.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims.

FIG. 1 shows a schematic cross sectional view of an upper assembly being inserted into a cavity of a sole molding unit as it is performed in an embodiment of the invention;

FIG. 2 shows a schematic view onto a heel edge of a shoe according to an embodiment of the invention and/or having been obtained by the method according to an embodiment of the invention;

FIG. 3 shows a schematic view of how an upper assembly can be provided according to an embodiment of the invention and/or a show production system according to an embodiment of the invention;

FIG. 4 shows a schematic top view of a nozzle as it can be used in some embodiments of the invention;

FIG. 5 shows a schematic perspective view of a nozzle as it can be used in some embodiments of the invention; and

FIG. 6 shows a detailed view of a depositing unit as it can be used in some embodiments of the invention.

### DESCRIPTION OF THE EMBODIMENTS

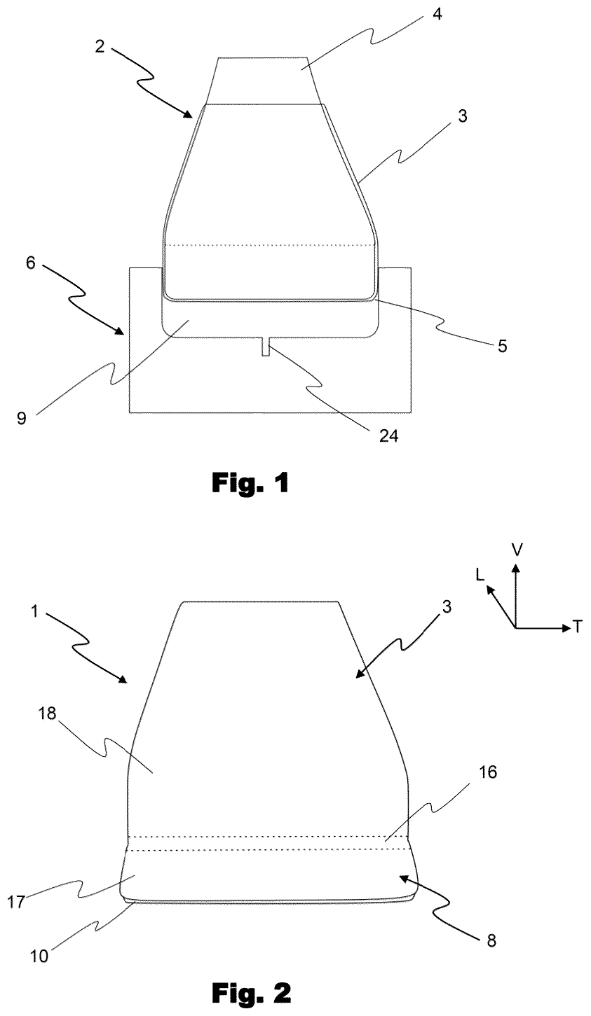

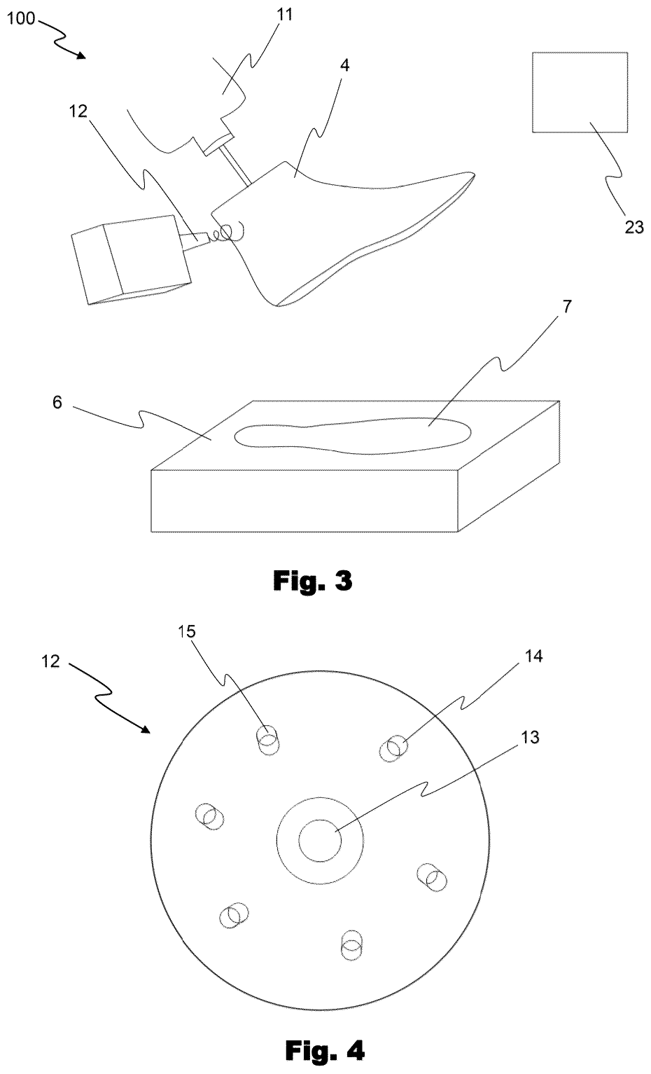

FIG. 1 shows an upper assembly 2 which comprises a carrier 4 and an upper 3 being mounted on carrier 4. Carrier 4 can in this embodiment or any other embodiment described herein for example be a last, i.e. a shoe last. Upper 3 further comprises bottom section 5 which is made from a thermoplastic polymer upper material. In this embodiment, the boundary of bottom section 5 is indicated by the dashed line. However, it may in some embodiments well be the case that the bottom section and the rest of the upper are identical, e.g. they may be made from the same material and/or have the same structure, such as a non-woven, knit or woven structure. Upper assembly 2 is partially inserted into cavity 7 (see FIG. 3) defined by sole molding unit 6. Thereby, the upper assembly 2 and the sole molding unit 6 define together sole molding compartment 9. Sole molding compartment 9 is a part of the cavity defined by sole molding unit 6. The upper assembly, in particular upper 3, respectively its bottom section 5, and the sole molding unit 6 form together a fluid tight connection. Typically, when upper assembly 2 is inserted into cavity 7, cavity 7 and therefore also sole molding compartment 9 is filled with air, e.g. ambient air. It may also in this or any other embodiment as described herein be possible to apply a sub-atmospheric pressure to sole molding compartment 9 after partially inserting upper assembly 2 into cavity 7 of sole molding unit 6.

As a next step, a midsole polymer composition comprising a molten thermoplastic polymer midsole material is introduced into the cavity and thus also into sole molding compartment 9. This introduction may for example occur via injection inlet 24 which opens into cavity 7, respectively sole molding compartment 9. Since upper assembly 2 is partially introduced into cavity 7 and/or the sole molding compartment 9 is defined by upper assembly 2 and sole molding unit 6, the introduced molten thermoplastic polymer composition is provided onto bottom section 5 of upper 3 being introduced into cavity 7. As the molten thermoplastic polymer midsole material has an equal or higher melting temperature than the thermoplastic polymer upper material of bottom section 5 (and optionally of complete upper 3), the bottom section 5 partially or fully melts and a material-bonded connection being a fused connection between upper and the formed foamed midsole occurs without any additional adhesive. Furthermore, during introduction, foaming of the molten thermoplastic polymer midsole material is performed during step d. which provides the foamed midsole. This results in a produced shoe with a foamed midsole being directly material-bonded, i.e. fused, to an upper 3. Subsequently, cooling and/or curing can be performed and the produced shoe can be removed from sole molding unit 6 and carrier 4 can be removed from the produced shoe.

FIG. 2 shows a shoe 1 which can be obtained by the method according to the invention. Shoe 1 comprises upper 3 and foamed midsole 8. Upper 3 comprises a thermoplastic polymer upper material and foamed midsole 8 comprises a thermoplastic polymer midsole material. In addition, shoe 1 comprises outsole 10 being material-bonded to foamed midsole 8. Outsole 10 can for example be obtained in that after step d. of the method according to the invention, i.e. after foamed midsole 8 is produced and material-bonded to upper 3, a molten polymer outsole material, preferably a molten thermoplastic outsole material is introduced into cavity 7 defined by sole molding unit 6, respectively sole molding compartment 9 onto foamed midsole 8. Introduction of the molten polymer outsole material may for example occur via injection inlet 24 or via an additional separate injection inlet. Only thereafter the thus produced shoe is typically removed from sole molding unit 6 and carrier 4 is removed from upper 3.

FIG. 2 shows a view of shoe 1 on its heel edge, i.e. as indicated by the coordinate system along longitudinal direction L towards the sole tip of shoe 1. Vertical direction V extends perpendicularly thereto from foamed midsole 8 towards upper 3, respectively in the worn or operative state from the ground to the foot of the wearer. Transversal direction T is perpendicular to both longitudinal direction L and vertical direction V. Shoe 1 further comprises intermediate material zone 16 which is indicated by the two parallel extending dashed lines. When the molten thermoplastic polymer midsole material is introduced, e.g. injected, onto bottom section 5 of upper 3, bottom section 5 at least partially or fully melts and therefore forms upon cooling/and or curing a material-bonded, e.g. fused, connection between foamed midsole 8 and upper 3. Thereby intermediate material zone 16 can be formed, which comprises both the thermoplastic polymer upper material of the upper, respectively bottom section 5 and also the thermoplastic polymer midsole material. In contrast, midsole section 17, i.e. the rest of foamed midsole 8 is devoid of the thermoplastic polymer upper material. Vice versa, upper section 18 of upper 3, i.e. the rest of upper 18, is devoid of the thermoplastic polymer midsole material. Against vertical direction V there is a gradient of the thermoplastic polymer upper material in intermediate material zone 16 extending from upper section 18 to midsole section 17. This gradient is decreasing, i.e. the amount, such as the mass percentage, of the thermoplastic polymer upper material decreases from the intermediate material zone 16 extending from upper section 18 to midsole section 17. Furthermore, there is an opposite gradient in intermediate material zone 16 of the thermoplastic polymer midsole material extending along or in vertical direction V, i.e. from midsole section 17 to upper section 18. The gradient of the thermoplastic polymer midsole material decreases in intermediate material zone 16 from midsole section 17 to upper section 18. The gradient may also in this case be represented by a decreasing amount, e.g. mass percentage, of the thermoplastic polymer midsole material. In some embodiments, the intermediate material zone 16 may extend completely along the transverse direction T and the longitudinal direction L of shoe 1 and for example completely separate midsole section 17 from upper section 18. However, it may generally also be possible that intermediate material zone 16 may extend only along a certain portion of the transverse direction T and/or the longitudinal direction L of shoe 1. For example, the intermediate material zone may only be arranged at the periphery of shoe 1 and thus not in its center.

FIG. 3 shows a shoe production system 100 when being used to produce a shoe, e.g. for producing a shoe in the method according to the invention. Shoe production system 100 comprises sole molding unit 6, such as sole molding unit 6 as described with respect to FIG. 1, which defines cavity 7 being configured for molding a shoe sole, such as foamed midsole 8. Cavity 7 is defined by sidewalls circumferentially surrounding the cavity and bottom wall delimiting the bottom of the cavity (not visible). As can be seen, the cavity is open at the top portion, which allows to insert upper assembly 2 directly into cavity 7. Furthermore, shoe production system 100 comprises movable robotic arm 11 which holds carrier 4. For example, robotic arm 11 may form a form-locking and/or force-locking engagement with carrier 4. It may for example be possible that robotic arm 11 forms a snap fitting engagement with carrier 4. Robotic arm 11 is configured for moving carrier 4 in the 3-dimensional space. Particularly, it may generally be possible that robotic arm 11 is configured to move carrier 4 along three space axes, such as a vertical axis, a longitudinal axis and a transversal axis. Additionally, or alternatively, it may generally be possible that the movable robotic arm 11 is configured for rotating carrier 4 around a rotation axis. Shoe production system 100 further comprises control unit 23 which is configured to control the movement of robotic arm 11, particularly with respect to nozzle 12 being further comprised in the shown shoe production system 100. Nozzle 12 which may be part of depositing unit (see FIG. 6).

FIG. 3 depicts how upper assembly 2 can be provided in step a of the method according to the invention. In this embodiment, the molten thermoplastic polymer upper material is applied by nozzle 12 onto carrier 4. The robotic arm moves carrier 4 in the 3 dimensional space with respect to nozzle 4. As can be seen, molten thermoplastic polymer upper material is applied as a filament onto carrier 4 as a helical filament. After the application of the molten thermoplastic polymer upper material is finished, the upper assembly 2 comprising carrier 4 and upper 3 being mounted on carrier 4 is provided. As a next step in the method according to the invention, the upper assembly 2 is at least partially inserted into cavity 7 of sole molding unit 6, for example in the manner as shown in FIG. 1. The insertion may for example be done by movable robotic arm 11 being preferably controlled by control unit 23. After the upper assembly 2 has been inserted into cavity 7, step d. of the method according to the invention is performed, i.e. the midsole polymer composition is introduced into cavity 7 and foaming of the molten thermoplastic polymer midsole material is performed to establish a direct fused connection between upper 3, respectively its bottom section 5, and foamed midsole 8 to produce shoe 1. Thus, the complete shoe can be produced at a single location with a single system and fully automatically.

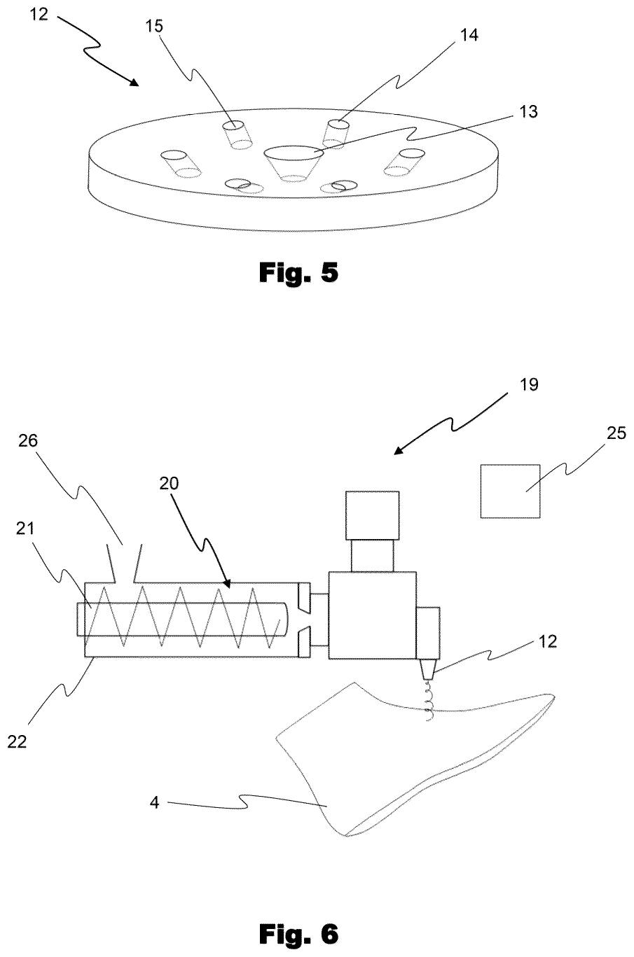

FIG. 4 shows a top view of nozzle 12 as it can be used in some embodiments of the invention. Nozzle 12 comprises centrally arranged material outlet 13. Furthermore, nozzle 12 comprises a plurality of air openings 14, 15 (only two openings are referenced for clarity purposes) being circumferentially arranged around material outlet 13. As can be seen, each air opening is arranged such that air being guided through it is guided inwardly, i.e. in the direction of the filament of molten thermoplastic upper material exiting material outlet 13. However, each air opening is also arranged such that pressurized air being guided through the air openings is applied in such a manner on the molten polymer upper material exiting the material outlet (i.e. the filament) that it is applied to the carrier as a helical filament. This is achieved by directing the pressurized air offset to the axis being perpendicular to material outlet 13 and extending through its center along the application direction in which the molten thermoplastic polymer material is applied to the carrier (i.e. in the direction the viewer views onto the nozzle in FIG. 4). This allows to effect a movement of the exiting molten thermoplastic polymer material such that it is applied onto the carrier as a helical filament. FIG. 5 shows a perspective view of nozzle 12 shown in FIG. 4, which further clarifies the configuration of air openings 14 and 15.

FIG. 6 shows a detailed view of a depositing unit 19 as it can be used in some embodiments of the invention. Depositing unit 19 comprises melting unit 20 which may be an extruder, such as a screw and barrel extruder having screw 21 and barrel 22. Melting unit 20 comprises material inlet 26 through which the thermoplastic polymer upper material can be inserted into melting unit 20 for example as solid granulate. This material is then melted inside melting unit 20 and transported towards nozzle 12 which may be a nozzle as shown in FIGS. 4 and 5. The molten thermoplastic polymer upper material is then applied via material outlet 13 out of nozzle 12. By means of pressurized air being applied through air inlet openings 14, 15 (see FIGS. 4 and 5), the molten thermoplastic polymer upper material is applied to carrier 4 as a helical filament. By moving carrier 4 in the 3-dimensional space, for example by a movable robotic arm (not shown here, see FIG. 3), an upper assembly 2 can be provided. The depositing unit can be controlled by depositing unit control unit 25. It may be possible that depositing unit control unit 25 is in some embodiments included into control unit 23 which controls the movement of movable robotic arm 11 (see FIG. 3).

1. A method for producing a shoe (1), the method comprising the steps:
a. providing an upper assembly (2), wherein the upper assembly comprises an upper (3) being mounted on a carrier (4), wherein the upper (3) comprises a bottom section (5) being made from a thermoplastic polymer upper material;
b. providing a sole molding unit (6), wherein the sole molding unit defines a cavity (7);
c. inserting the upper assembly (2) at least partially into the cavity (7); and
d. introducing a midsole polymer composition comprising a molten thermoplastic polymer midsole material which has a melting temperature equal or higher than the melting temperature of the thermoplastic polymer upper material into the cavity (7) and foaming the molten thermoplastic polymer midsole material inside the cavity (7) to provide a foamed midsole (8) and to establish a material-bonded, in particular fused, connection between the upper (3) and the foamed midsole (8).

2. The method according to claim 1, wherein step d. is performed by supercritical injection foaming.

3. The method according to claim 1, wherein the polymer composition in step d. comprises a physical blowing agent, in particular a physical blowing agent being in a supercritical state.

4. The method according to claim 1, wherein during step d. the bottom section (5) of the upper (3) is at least partially melted, in particular by the thermal energy of the molten thermoplastic polymer midsole material.

5. The method according to claim 1, wherein in step c. the upper assembly (2) is inserted such into the sole molding unit (6) that a closed, and in particular sealed, sole molding compartment (9) is formed being defined by the sole molding unit (6) and the upper assembly (2).

6. The method according to claim 1, wherein after step d. an outsole polymer composition comprising a molten polymer outsole material is introduced into the cavity (7) to provide an outsole (10) being material-bonded, in particular fused, to the foamed midsole (8).

7. The method according to claim 1, wherein the upper assembly (2) provided in step a. is held by a movable robotic arm (11) and wherein step c. is performed by the robotic arm (11).

8. The method according to claim 1, wherein the upper assembly (2) in step a. is provided by applying the molten thermoplastic polymer upper material onto the carrier (4) by means of a nozzle (12) in the form of at least one filament, in particular at least one continuous filament, to provide the upper (3) being mounted on the carrier (4).

9. The method according to claim 8, wherein the at least one filament is applied such on the carrier (4) that it forms a plurality of crossings with itself on the carrier (4) and/or a plurality of loops on the carrier (4), wherein a material-bonded connection is established at at least one crossing between different sections of the at least one filament.

10. The method according to claim 8, wherein the nozzle (12) comprises a material outlet (13) and a plurality of air openings (14, 15) being circumferentially arranged around the material outlet (13), wherein pressurized air is applied in such a manner onto the molten polymer upper material exiting the material outlet (13) that it is applied to the carrier (4) as a helical filament.

11. A shoe (1), in particular having been obtained by the method according to claim 1, the shoe (1) comprising an upper (3) comprising a thermoplastic polymer upper material and a foamed midsole (8) comprising a thermoplastic polymer midsole material, wherein the upper (3) and the foamed midsole (8) are directly material-bonded, in particular fused, with each other.

12. The shoe (1) according to claim 11, wherein the shoe (1) further comprises an intermediate material zone (16) in which the upper (3) and the foamed midsole (2) are directly material-bonded with each other, wherein the intermediate material zone (16) comprises the thermoplastic polymer upper material and the thermoplastic polymer midsole material.

13. The shoe (1) according to claim 12, wherein the intermediate material zone (16) is arranged between a midsole section (17) being devoid of the thermoplastic polymer upper material and an upper section (18) being devoid of the thermoplastic polymer midsole material.

14. The shoe (1) according to claim 12, wherein the intermediate material zone (16) comprises a gradient of the thermoplastic polymer upper material, which extends from the upper section (18) to the midsole section (17), and/or wherein the intermediate material zone (16) comprises a gradient of the thermoplastic polymer midsole material which extends from the midsole section (17) to the upper section (18).

15. The shoe (1) according to claim 11, wherein the melting temperature of the thermoplastic polymer midsole material is equal or higher than the melting temperature of the thermoplastic polymer upper material.

16. A shoe production system (100) configured for performing the method according to claim 1, the shoe production system (100) comprising a sole molding unit (6) which defines a cavity (7) and a movable robotic arm (11) being configured to hold the carrier (4) of the upper assembly (2).

17. The shoe production system (100) according to claim 16, further comprising a depositing unit (19) configured for depositing a thermoplastic polymer upper material on the carrier (4) held by the movable robotic arm (11).

18. The shoe production system (100) according to claim 17, wherein the depositing unit (19) comprises a nozzle (12).

19. The shoe production system (100) according to claim 18, wherein the nozzle (12) comprises a material outlet (13) and a plurality of air openings (14, 15) being circumferentially arranged around the material outlet (13) and configured to apply pressurized air in such a manner onto the molten thermoplastic polymer upper material exiting the material outlet (13) that it is applied to the carrier (4) as a helical filament.

20. The shoe production system (100) according to claim 18, wherein the depositing unit (19) further comprises a melting unit (20) with an extruder with screw (21) and barrel (22), in fluidic communication with the material outlet (13) of the nozzle (12).
